(19) United States
(12) Patent Application Publication
(10) Pub. No.: US 2009/0018264 A1
(43) Pub. Date: Jan. 15, 2009

(54) RESIN COMPOSITION

(75) Inventor: Atsushi Fuseya, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/031,985

(22) Filed: Feb. 15, 2008

(30) Foreign Application Priority Data
Jul. 12, 2007 (JP) 2007-183201

(51) Int. Cl. C08K 3/36

(52) U.S. Cl. 524/604

(57) ABSTRACT

In order to provide a resin composition which contains a polymer having a furan ring and a layer silicate composition and is excellent in heat resistance and mechanical strength, the present invention provides a resin composition which contains a layer silicate composition and a polymer having a repeating unit represented by the following formula (1).

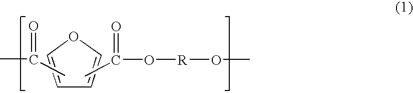

(wherein R represents a group having a valence of 2 or more and selected from the group consisting of an aromatic group, an aliphatic hydrocarbon group and an alicyclic hydrocarbon group.)

### BACKGROUND OF THE INVENTION

1. Field of the Invention

The present invention relates to a resin composition which contains a polymer having a furan ring and a layer silicate composition and is excellent in heat resistance and mechanical strength.

2. Description of the Related Art

In late years, utilization of recyclable organic resources derived from organisms (except for fossil resources) (i.e. biomass) attracts attention from the viewpoint of environmental protection. Among plastics, polylactic acid attracts attention as a plastic which utilizes organic resources mainly derived from plants as raw materials. Lactic acid, which is the raw material thereof, can be obtained by fermenting starch such as that of corn or sweet potato. Polylactic acid is, however, inferior to conventional plastics in strength and heat resistance in many cases, and the use thereof has been limited to casing, tableware and the like.

Meanwhile, a process for producing furfural from raw materials derived from plants is reported, and the application thereof is expected (See Japanese Patent Application Laid-Open No. 2005-200321 and Japanese Patent Application Laid-Open No. 2005-232116.).

In addition, it has been proposed to add a petroleum-derived thermoplastic resin to polylactic acid as an example of improving heat resistance and mechanical strength of a thermoplastic resin which utilizes biomass as raw materials (For example, See U.S. Pat. No. 5,952,450 and US Patent Application Publication No. 2001/0051692.). This method, however, requires to add a large amount of a petroleum-derived thermoplastic resin in order to achieve desired heat resistance, which causes concern in the role as an environment-conscious material.

It is generally well known to add an inorganic filler such as talc, glass fiber, carbon fiber as a method for improving heat resistance and mechanical strength of a resin. This method, however, requires to add a large amount of an inorganic filler in order to achieve desired properties, which increases the specific gravity of the resin. Furthermore, there have been caused problems such as deterioration in moldability and appearance.

In late years, resin compositions added with, among inorganic fillers, a layer silicate processed with an organic onium compound has been suggested in order to improve the heat resistance and the mechanical strength of a thermoplastic resin. As for the production method thereof, a method including melt-kneading a thermoplastic resin and a layer silicate which is processed with an organic onium compound with a twin screw extruder has been suggested (See Japanese Patent Application Laid-Open No. 2004-27136.). A method including polymerizing monomers to form a thermoplastic resin in the presence of a layer silicate processed with an organic onium compound has been also suggested (See Japanese Patent No. 2627194.).

### SUMMARY OF THE INVENTION

However, it is supposed that further improvement in the properties is needed in order to apply such a resin composition to high-performance parts which require high heat resistance and high strength.

Accordingly, an object of the present invention is to provide a resin composition which contains a polymer having a furan ring and a layer silicate composition and is excellent in heat resistance and mechanical strength.

The present inventor has conducted studies paying attention to a polymer having a furan ring and a layer silicate composition which is obtained by organizing a layer silicate. The present inventor has found in these studies that a resin composition excellent in mechanical strength and heat resistance can be provided by binding organic onium ions held between layers of a layer silicate and a polymer having a furan ring. Furthermore, the present inventor has found that this resin composition has properties sufficiently applicable for use in optical apparatuses, bottles and housing materials and thus completed the present invention.

That is, the present invention which has solved the above-mentioned problems relates to a resin composition which includes a layer silicate composition and a polymer having a repeating unit represented by the following formula (1).

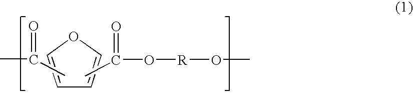

(wherein R represents a group having a valence of 2 or more and selected from the group consisting of an aromatic group, an aliphatic hydrocarbon group and an alicyclic hydrocarbon group.)

The present invention has the following effects. That is, by introducing a layer silicate composition obtained by organizing a layer silicate into a polymer having a furan ring, a resin composition which has further improved heat resistance and mechanical strength as compared with polymers having a furan ring can be provided.

Further features of the present invention will become apparent from the following description of exemplary embodiments.

### DESCRIPTION OF THE EMBODIMENTS

The polymer having a furan ring in the present invention has a repeating unit represented by the above formula (1). The number of the repeating units represented by the formula (1) contained in the polymer is preferably 10 units or more. Here, the polymer may be a homopolymer composed of one kind of a repeating unit represented by the formula (1) or may be a copolymer in which R is composed of two or more different repeating units. The ratio of the repeating unit(s) represented by the formula (1) contained in the polymer is not particularly limited as long as the desired characteristics such as moldability of the resin composition containing the polymer, strength and heat resistance of molded articles obtained by using the resin composition can be satisfied.

The number average molecular weight of the polymer having a repeating unit represented by the formula (1) is preferably 39,000 or more. When the number average molecular weight is smaller than 39000, application in optical apparatuses, bottles and housing materials may be difficult.

R in the formula (1) represents a group having a valence of 2 or more and selected from the group consisting of an aromatic group, an aliphatic hydrocarbon group and an alicyclic hydrocarbon group.

Examples of the aromatic group having a valence of 2 or more include aromatic groups having a valence of 2 or more containing a benzene ring, a biphenyl ring, condensed rings such as a naphthalene ring, an indene ring, an anthracene ring and a phenanthrene ring. Specific examples thereof include p-phenylene, o-phenylene, 1,1′-biphenyl-4,4′-diyl, 1,1′-biphenyl-2,2′-diyl, naphthalene-1,8-diyl, naphthalene-2,6-diyl, indene-2,3-diyl, anthracene-1,4-diyl, anthracene-9,10-diyl, phenanthrene-1,2-diyl, phenanthrene-3,4-diyl, phenanthrene-9,10-diyl and biphenylene. Examples of the compound having a biphenylene group include bis(2-hydroxyphenyl)methane and 2,2′-bis(hydroxyphenyl)propane. Meanwhile, examples of the aromatic group having a heterocycle include aromatic groups having a five-membered heterocycle such as a furan ring, a thiophene ring, a pyrrole ring, an oxazole ring, a thiazole ring and an imidazole ring, for example, furan-2,5-diyl, furan-2,3-diyl, furan-2,4-diyl, furan-3,4-diyl, thiophene-2,5-diyl, thiophene-2,4-diyl, pyrrole-2,5-diyl, pyrrole-2,3-diyl, oxazole-2,5-diyl, thiazole-2,4-diyl, thiazole-2,5-diyl, imidazole-2,5-diyl. In addition, for example, aromatic groups having a six-membered heterocycle such as a pyran ring, a pyridine ring, a pyridazine ring, a pyrimidine ring and a pyrazine ring, for example, pyran-3,6-diyl, pyridine-2,3-diyl, pyridine-2,4-diyl, pyridazine-3,4-diyl, pyrimidine-2,4-diyl, pyrazine-2,3-diyl and pyrazine-2,6-diyl are also included. Besides, for example, aromatic groups having a condensed ring such as an indole ring, a carbazole ring, a coumalin ring, a quinoline ring, an isoquinoline ring, an acridine ring, a benzothiazole ring, a quinoxaline ring and a purine ring, for example, indole-2,3-diyl, indole-2,6-diyl, carbazole-2,7-diyl, coumalin-3,4-diyl, quinoline 2,3-diyl, isoquinoline-3,4-diyl, isoquinoline-6,7-diyl, acridine-1,4-diyl, benzothiazole-6,7-diyl, quinoxaline-5,8-diyl, purine-2,6-diyl are included.

Examples of the aliphatic hydrocarbon group having a valence of 2 or more include ethane-1,2-diyl, propane-1,2-diyl, propane-2,2-diyl, propane-1,3-diyl, butane-1,2-diyl, butane-1,3-diyl, butane-1,4-diyl, pentane-1,5-diyl, 2-methylbutane-1,4-diyl, 2,2-dimethylpropane-1,3-diyl. Examples of more preferable aliphatic hydrocarbon groups include linear or branched alkylene groups having 2 to 4 carbon atoms such as ethane-1,2-diyl, propane-1,2-diyl and butane-1,4-diyl and butane-1,3-diyl.

Examples of the alicyclic hydrocarbon group having a valence of 2 or more include groups having a valence of 2 or more selected from a cycloalkylene group and a cycloalkenyl group. Examples of the cycloalkylene group include cyclopentane-1,2-diyl, cyclohexane-1,2-diyl, cycloheptane-1,2-diyl, cyclooctane-1,2-diyl, cyclononane-1,2-diyl and cyclodecane-1,2-diyl. Examples of the cycloalkenyl group include cyclobut-2-ene-1,2-diyl, cyclopent-2-ene-1,2-diyl, cyclohex-2-ene-1,2-diyl, cyclohept-2-ene-1,2-diyl and cycloocta-2-ene-1,2-diyl.

These aromatic groups, aliphatic hydrocarbon groups and alicyclic hydrocarbon groups may be substituted. Examples of the substituent group include various groups containing a hetero atom such as an oxygen atom, a nitrogen atom, a silicon atom and a halogen atom, for example, an aliphatic oxy group, an aromatic oxy group, a siloxy group, an amino group, a nitro group, a cyano group, a silyl group and a halogeno group. Specific examples of the aliphatic group of the aliphatic oxy group include a methyl group, an ethyl group, a propyl group, a butyl group, a hexyl group, an octyl group, a cyclohexylmethyl group, a trimethylsiloxyhexyl group, a chloroethyl group, a methoxybutyl group, a dimethylaminomethyl group, a butenyl group and an octenyl group. Examples of the aromatic oxy group include a phenoxy group.

The resin composition of the present invention can be obtained by reacting a mixture containing a compound represented by the following formula (2) or a furandicarboxylic acid anhydride, a polyhydric alcohol represented by the following formula (3), and a layer silicate composition. Alternatively, the resin composition can be obtained by obtaining a polymer having a repeating unit represented by the formula (1) by reacting a compound represented by the following formula (2) or a furandicarboxylic acid anhydride and a polyhydric alcohol represented by the following formula (3), and then melt-kneading the polymer obtained and a layer silicate composition.

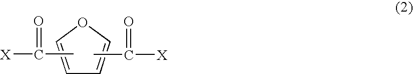

(wherein X represents a hydroxy group, an alkoxy group or a halogen atom.)

R¹(OH)ₘ (3)

(wherein R¹ represents a group having a valence of m and selected from the group consisting of an aromatic group, an aliphatic hydrocarbon group and an alicyclic hydrocarbon group, and m represents an integer of 2 or more.)

Examples of the compound represented by the formula (2) include furandicarboxylic acid in which X is a hydroxy group and furandicarboxylic acid derivatives in which X is an alkoxy group or a halogen atom. At least one kind of furandicarboxylic acid, an acid anhydride thereof, the furandicarboxylic acid derivatives thereof and a polyhydric alcohol represented by the formula (3) may have been produced from biomass.

Specific examples of the furandicarboxylic acid include 2,3-furandicarboxylic acid, 2,4-furandicarboxylic acid, 2,5-furandicarboxylic acid and 3,4-furandicarboxylic acid. Here, the alkoxy group in the formula (2) is preferably a methoxy group and an ethoxy group. In addition, it is preferable that the halogen atom in the formula (2) is chlorine. Furthermore, the furandicarboxylic acid represented by the formula (2), can be produced by known methods from so-called plant raw materials (biomass) such as cellulose, glucose and fructose. Examples of the furandicarboxylic acid anhydride include furandicarboxylic acid-2,3-anhydride represented by the following formula (5) and furandicarboxylic acid-3,4-anhydride represented by the following formula (6). In addition, it is preferable that the compound represented by the formula (2) is at least one compound selected from the group consisting of 2,5-furandicarboxylic acid, dimethyl 2,5-furandicarboxylate, diethyl 2,5-furandicarboxylate and 2,5-furandicarboxylic acid dichloride. When these compounds, which can be derived from plant, are used, resin compositions excellent in physical properties can be obtained.

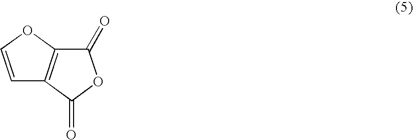

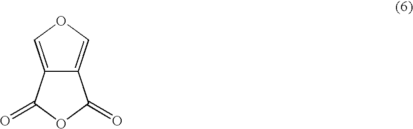

Examples of the aromatic group in R¹ of the formula (3) include various aromatic groups exemplified for R of the formula (1).

Examples of the aliphatic hydrocarbon group in R¹ of the formula (3) include various aliphatic hydrocarbon groups exemplified for R of the formula (1) in addition to hydrocarbon groups such as an alkylene group. Examples of the preferable aliphatic hydrocarbon group include linear or branched alkylene groups having 2 to 4 carbon atoms such as ethane-1,2-diyl, propane-1,2-diyl, butane-1,4-diyl and butane-1,3-diyl.

Examples of the alicyclic hydrocarbon group in R¹ of the formula (3) include a cycloalkylene group and a cycloalkenyl group and can include alicyclic hydrocarbon groups exemplified for R of the formula (1).

These aromatic groups, aliphatic hydrocarbon groups and alicyclic hydrocarbon groups may be substituted. Examples of these substituent groups include various substituent groups exemplified for R of the formula (1).

OH in the formula (3) is a hydroxy group substituted on R¹, and the number m of the substitution unit is the same as the valence of R and it is 2 or more. Usually m is preferably 2.

Specific examples of the polyhydric alcohol represented by the formula (3) include aromatic, aliphatic or alicyclic diols and can include dihydroxybenzene, bisphenol, glycerin, trimethylolpropane, pentaerythritol, sorbitol and saccharides. In addition, ether diols obtained by intermolecular dehydration of diols as well as oxycarboxylic acids such as dihydroxybenzoic acid can be exemplified.

Specific examples of the aliphatic or alicyclic diols include ethylene glycol, 1,3-propanediol, 1,4-butanediol and 1,4-cyclohexanedimethanol. Examples of the dihydroxybenzene include 1,3-dihydroxybenzene and 1,4-dihydroxybenzene.

Examples of the bisphenol include bis(2-hydroxyphenyl)methane, 2,2′-bis(hydroxyphenyl)propane and 2,2′-bis(4-hydroxyphenyl)-sulfone.

In preferable embodiments, diol is used as the polyhydric alcohol, and this diol is exemplified by ethylene glycol, 1,3-propanediol or 1,4-butanediol, which are produced from plant raw materials.

The layer silicate composition used for the present invention is preferably obtained by organizing a layer silicate with a hydroxylammonium compound. Resin compositions excellent in heat resistance and mechanical strength can be obtained by using such a layer silicate composition.

The layer silicate used for the present invention is not particularly limited as long as it has properties to swell in a dispersion solvent and the examples thereof include smectite clay mineral and kaolin clay mineral, expandable mica and vermiculite. Specific examples of the smectite clay mineral include montmorillonite, saponite, beidellite, nontronite, stevensite and bentonite. Specific examples of the kaolin clay mineral include kaolinite, dickite and halloysite. Examples of the expandable mica include lithium type taeniolite, sodium type taeniolite, lithium type tetrasilicate and sodium type tetrafluorosilicate. The vermiculite is classified into trioctahedral vermiculite by the ion ratio of the octahedron. These layer silicates may be substituted silicates or derivatives thereof, and they may be natural, synthetic or processed products. One of these may be used alone or two or more kinds of them may be used in combination.

For the hydroxyammonium compound for organizing the layer silicate used in the present invention, trimethyl(2-hydroxyethyl)ammonium chloride (alias: choline chloride), oleylbis(2-hydroxyethyl)methylammonium chloride, methyl/tallowbis(2-hydroxyethyl)methylammonium chloride, alkylbis(2-hydroxyethyl)methylammonium chloride are preferable. When these hydroxyammonium compounds are used, the obtained layer silicate composition can be easily dispersed in a polymer having a repeating unit represented by the formula (1), and a resin composition excellent in heat resistance and mechanical strength can be obtained.

Furthermore, a compound represented by the following formula (4) is preferable for the hydroxyammonium compound for organizing the layer silicate when a layer silicate composition to be melt-kneaded with a polymer having a repeating unit represented by the formula (1) is obtained.

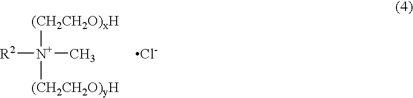

(wherein R² represents a hydrogen atom or a saturated or unsaturated hydrocarbon group having 1 or more and 25 or less carbon atoms, x and y may be the same or different, and the total of x and y represents an integer of 2 or more and 10 or less.)

In the above-formula (4), R² represents a hydrogen atom or a saturated or unsaturated hydrocarbon group having 1 or more and 25 or less carbon atoms. The number of carbon atoms is preferably 8 or more and more preferably 12 or more. When the number of carbon atoms is less than 8, distance between layers of the layer silicate is not expanded enough, and dispersion in the polymer having a repeating unit represented by the formula (1) during melt-kneading may be insufficient. On the other hand, when the number exceeds 25, synthesis of the hydroxyammonium compound may be difficult. Preferable examples of the saturated hydrocarbon group include a lauryl group, a stearyl group and a behenyl group, and those of the unsaturated hydrocarbon group include an oleyl group.

In addition, x and y in the formula (4) represent a degree of polymerization of ethylene oxide (—CH₂CH₂O—) and x and y may be the same or different, and preferably the total of x and y is an integer of 2 or more and 10 or less, and more preferably it is 5. When the total of x and y exceeds 10, the hydrophilicity of the organized layer silicate composition increases, and suction filtration in the organizing step may be difficult. Furthermore, the dispersion to the polymer having a repeating unit represented by the formula (1) may become insufficient, and the heat resistance of the resin composition tends to deteriorate.

Next, the first and the second production processes of the resin composition of the present invention will be described.

The first production process of the resin composition of the present invention has the following steps.

(A1) Step of organizing the layer silicate with a hydroxyammonium compound to obtain a layer silicate composition.

(B1) Step of charging a furandicarboxylic acid compound represented by the formula (2) or furandicarboxylic acid anhydride, a polyhydric alcohol represented by the formula (3) and a layer silicate composition into a reactor and performing esterification reaction in the presence of a catalyst to obtain an ester compound.

(C1) Step of performing polycondensation of the thus obtained ester compound.

Examples of the reaction method (polymerization method) in the first production process of the resin composition of the present invention include conventional methods such as solution polymerization, bulk polymerization, suspension polymerization, emulsion polymerization, and a method is appropriately selected depending on the kind of molded articles. As for the polymerization temperature, polymerization catalyst, mediums such as solvents, those following the respective polymerization method can be used.

The polycondensate in the molten condition resulted in the end of this polycondensation process can be used as it is or after processed into forms such as pellets by adding various additives such as a stabilizer various additives to form molded articles.

Further, an embodiment of the first production process of the resin composition of the present invention is described in detail by way of an example.

At first, the above step (A1) is described. In the step (A1), 0.1 to 5 parts by mass of a layer silicate are mixed with 100 parts by mass of water to prepare a layer silicate dispersion. 5 to 15 parts by mass of a hydroxyammonium compound are added to 100 parts by mass of water prepared separately to prepare an aqueous solution of the hydroxyammonium compound. Then the aqueous solution of the hydroxyammonium compound is added to a dispersion liquid of the layer silicate so that 8 to 50 parts by mass of the hydroxyammonium compound may be added to 100 parts by mass of the layer silicate. The mixture is warmed to 50 to 70° C. and stirred for 50 to 100 minutes to perform organization of the layer silicate. After the organization is finished, the mixture is filtered and rinsed to remove the remaining hydroxyammonium compound. This is dried at 60 to 100° C. for 3 to 6 hours and pulverized to prepare a layer silicate composition. The obtained layer silicate composition usually contains 6 to 46 parts by mass of a hydroxyammonium compound for 100 parts by mass of a layer silicate.

Then in the step (B1), a furandicarboxylic acid compound represented by the formula (2) or furandicarboxylic acid anhydride, a polyhydric alcohol represented by the formula (3), a layer silicate composition and a catalyst or a catalyst mixture are charged into a reactor. The materials charged into the reactor are slowly heated to 110° C. to 200° C., preferably 150° C. to 180° C. while being stirred. Thereby, esterification between furandicarboxylic acid and the polyhydric alcohol and esterification between furandicarboxylic acid and a hydroxyammonium compound contained in the layer silicate composition are performed. An oligomer is generated by this procedure.

Then in the step (C1), the reaction system is heated to a temperature in the range of 180° C. to 280° C., preferably 180° C. to 230° C. Transesterification reaction is caused by this procedure to perform polycondensation aimed at increasing the molecular weight. It is preferable to carry out this polycondensation reaction under reduced pressure. It is usually preferable to perform polycondensation reaction at a pressure of 133 Pa or less. In the polycondensation reaction, polyhydric alcohols are generated as by-products. The polyhydric alcohols can be easily removed by performing polycondensation reaction under reduced pressure. This procedure increases the reaction rate of the polycondensation reaction and enables to increase the molecular weight of the polymer in the obtained resin composition. This procedure of heating, stirring and decompression is continued until the molecular weight reaches to a molecular weight at which the molding of the molded articles can be achieved or the specification of the molded articles can be achieved.

Next, the amount of the monomer and so on to be charged into the reactor is described in detail. The amount of polyhydric alcohol represented by the formula (3) to be charged into the reactor is preferably 1 to 3 times of the molar number of the compound represented by the formula (2) or furandicarboxylic acid anhydride. Excessive polyhydric alcohol and polyhydric alcohols generated as the polycondensation proceeds are preferably removed by evaporation by reducing the pressure of the reaction system or azeotropically removed together with another solvent or removed from the reaction system by other methods.

The amount of the layer silicate composition to be charged into a reactor is described in detail. The amount of the layer silicate composition to be charged into a reactor is preferably added so that the content of the layer silicate composition in the obtained resin composition may be 1 part by mass or more and 20 parts by mass or less for 100 parts by mass of the polymer. When the content of the layer silicate composition is less than 1 part by mass, desired effects of improving properties may not be obtained. When the content of the layer silicate composition exceeds 20 parts by mass, dispersion of the layer silicate composition may be insufficient, and there are cases where the properties deteriorate. More preferably, the content of the layer silicate composition is 1 to 10 parts by mass for 100 parts by mass of the polymer.

Next, the catalyst is described. The reaction of a compound represented by the formula (2) or furandicarboxylic acid anhydride and a polyhydric alcohol represented by the formula (3) and the reaction of a compound represented by the formula (2) or furandicarboxylic acid anhydride and hydroxyammonium contained in the layer silicate composition proceed even if no catalyst is added due to the autocatalytic effect of the dicarboxylic acid or furandicarboxylic acid anhydride. However, since the concentration of the dicarboxylic acid or furandicarboxylic acid anhydride decreases with the progress of the polymerization, it is preferable to add a catalyst. The synthesis of the polymer represented by the formula (1) in the present invention contains two reactions, i.e., esterification reaction and polycondensation reaction by transesterification, and there are respectively preferable catalysts.

Examples of the catalyst which is suitable for the esterification reaction in the step (B1) include metal oxides and salts, organometallic compounds of tin, lead, titanium, etc. and quadrivalent hafnium compounds such as hafnium (IV) chloride and hafnium (IV) chloride-(THF)₂. Examples of the catalyst which is optimal for the polycondensation reaction in the step (C1) include acetates and carbonates of lead, zinc, manganese, calcium, cobalt, magnesium, etc. and metal oxides of magnesium, zinc, lead, antimony, etc. and organometallic compounds of tin, lead, titanium, etc. For the catalyst which is effective in the both steps, titanium alkoxides are particularly preferable.

Appropriate catalysts may be added in each step of the step (B1) and the step (C1). Alternatively, any combination selected from the above catalyst group may be charged along with a compound represented by the formula (2) or furandicarboxylic acid anhydride or a polyhydric alcohol represented by the formula (3). Needless to say, the catalyst may be appropriately added to the raw materials while they are heated and, further, the catalyst may be added divided into plural portions in any combination.

Each condition in the production process described above can be applied when two or more kinds of the compound(s) represented by the formula (2) and furandicarboxylic acid anhydride and two or more kinds of the polyhydric alcohols represented by the formula (3) are used.

The second production process of the resin composition of the present invention has the following steps.

(A2) Step of organizing the layer silicate with a hydroxyammonium compound to obtain a layer silicate composition.

(B2) Step of charging a furandicarboxylic acid compound represented by the formula (2) or furandicarboxylic acid anhydride and a polyhydric alcohol represented by the formula (3) into a reactor and performing esterification reaction in the presence of a catalyst to obtain an ester compound.

(C2) Step of performing polycondensation of the thus obtained ester compound.

(D2) Step of melt-kneading the layer silicate composition obtained in the step (A2) and the polymer having a repeating unit represented by the formula (1) obtained in the step (B2) and (C2).

The step (A2) in the second production process is performed in the same way as the step (A1) in the first production process.

Then in the step (B2), a furandicarboxylic acid compound represented by the formula (2) or furandicarboxylic acid anhydride, a polyhydric alcohol represented by the formula (3) and a catalyst or a catalyst mixture are charged into a reactor. The materials charged into the reactor are slowly heated to 110° C. to 200° C., preferably 150° C. to 180° C. while being stirred and esterification between furandicarboxylic acid and the polyhydric alcohol is performed. An oligomer is generated by this procedure.

Then in the step (C2), the reaction system is heated to a temperature in the range of 180° C. to 280° C., preferably 180° C. to 230° C. Transesterification reaction is caused by this procedure to perform polycondensation aimed at increasing the molecular weight. It is preferable to carry out this polycondensation reaction under reduced pressure. It is usually preferable to perform polycondensation reaction at a pressure of 133 Pa or less. In the polycondensation reaction, polyhydric alcohols are generated as by-products. The polyhydric alcohols can be easily removed by performing polycondensation reaction under reduced pressure. This procedure increases the reaction rate of the polycondensation reaction and enables to increase the molecular weight of the polymer in the obtained resin composition. This procedure of heating, stirring and decompression is continued until the molecular weight reaches to a molecular weight at which the molding of the molded articles can be achieved or the specification of the molded articles can be achieved.

Next, the amounts of the monomer and so on to be charged into the reactor are described in detail. The amount of polyhydric alcohol represented by the formula (3) to be charged into the reactor is preferably 1 to 3 times of the molar number of the compound represented by the formula (2) or furandicarboxylic acid anhydride. Excessive polyhydric alcohol and polyhydric alcohols generated as the polycondensation proceeds are preferably removed by evaporation by reducing the pressure of the reaction system or azeotropically removed together with another solvent or removed from the reaction system by other methods.

Next, the catalyst is described. The reaction of a compound represented by the formula (2) or furandicarboxylic acid anhydride and a polyhydric alcohol proceeds even if no catalyst is added due to the autocatalytic effect of the dicarboxylic acid or furandicarboxylic acid anhydride. However, since the concentration of the dicarboxylic acid or furandicarboxylic acid anhydride decreases with the progress of the polymerization, it is preferable to add a catalyst. The synthesis of the polymer represented by the formula (1) in the present invention contains two reactions, i.e., esterification reaction and polycondensation reaction by transesterification, and there are respectively preferable catalysts.

Examples of the catalyst which is suitable for the esterification reaction in the step (B2) include metal oxides and salts, organometallic compounds of tin, lead, titanium, etc. and quadrivalent hafnium compounds such as hafnium (IV) chloride and hafnium (IV) chloride-(THF)₂. Examples of the catalyst which is optimal for the polycondensation reaction in the step (C2) include acetates and carbonates of lead, zinc, manganese, calcium, cobalt, magnesium, etc. and metal oxides of magnesium, zinc, lead, antimony, etc. and organometallic compounds of tin, lead, titanium, etc. For the catalyst which is effective in the both steps, titanium alkoxides are particularly preferable.

Appropriate catalysts may be added in each step of the step (B2) and the step (C2). Alternatively, any combination selected from the above catalyst group may be charged along with a compound represented by the formula (2) or furandicarboxylic acid anhydride or a polyhydric alcohol represented by the formula (3). Needless to say, the catalyst may be appropriately added to the raw materials while they are heated and, further, the catalyst may be added divided into plural portions in any combination.

Each condition in the production process described above can be applied when two or more kinds of the compound(s) represented by the formula (2) and furandicarboxylic acid anhydride and two or more kinds of the polyhydric alcohols represented by the formula (3) are used.

Then in the step (D2), the layer silicate composition obtained in the step (A2) and the polymer having a repeating unit represented by the formula (1) obtained in the step (B2) and (C2) are cast into a twin screw extruder and melt-kneaded. Preferably the temperature of this melt-kneading step is 160 to 220° C. When the temperature is less than 160° C., melting of the polymer becomes insufficient, and there are cases where the dispersion of the layer silicate composition becomes insufficient. On the other hand, when the temperature is more than 22° C., the polymer and the hydroxyammonium compound contained in the layer silicate composition start to decompose, and the properties of the resin composition obtained by melt-kneading may deteriorate.

Further, necessary amounts of additives such as a flame retardant, a coloring agent, an internal mold release agent, an antioxidant, a UV absorber, etc. may be added to a resin composition of the present invention.

### EXAMPLES

Hereinbelow, the present invention is described in detail by way of Examples.

The number average molecular weight of the polymer was measured in the Examples using the following apparatuses and conditions.

Analyzing apparatus: Alliance 2695 produced by Waters Corporation (brand name)
Detector: Differential refractometry detector
Eluant: Hexafluoroisopropanol solution having a concentration of 5 mM sodium trifluoroacetate
Flow rate: 1.0 ml/min
Column temperature: 40° C.

### Example 1

Water was warmed to around 60° C., and while being stirred, slowly added with montmorillonite (cation exchange capacity 115 milliequivalent/100 g, Kunipia F (brand name) produced by Kunimine Industries Co., Ltd.) equivalent to 1 mass % and continued to be stirred for one hour to prepare a montmorillonite dispersion. Then, 5 mass % choline chloride aqueous solution was separately prepared. The choline chloride aqueous solution was warmed to 60° C., slowly added with the montmorillonite dispersion while being stirred, and stirred for 24 hours while being warmed to 60° C. Then, this mixture was suction filtered with a Buchner funnel and the separated solid contents were subjected to around three sets of rinsing with warm water and filtration repeatedly. The separated solid contents were dried at 80° C. and pulverized to prepare a layer silicate composition.

A 1 L four-necked flask equipped with a nitrogen introduction pipe, a distilling tube-condenser tube, a thermometer and a stirring blade made of SUS was prepared. 2,5-furandicarboxylic acid (154.0 g) as a dicarboxylic acid and distilled 1,4-butanediol (270.3 g; molar ratio=1:3) as a diol were charged to this four-necked flask. Further, the layer silicate composition (11.05 g), 0.059 mass % of a tin catalyst (monotin oxide, Wako Pure Chemical Industries), 0.059 mass % of a titanium catalyst (butyl titanate, Kishida Chemical Co., Ltd.) dissolved in toluene were charged. Here, % value is based on the total mass of the cast materials.

Stirring was started while nitrogen was introduced into a four-necked flask and the flask was immersed in an oil bath at 150° C. to heat the content thereof. When the inner temperature reached about 150° C., by-product water generated by the condensation reaction began to flow out. The temperature was further elevated to 170° C. over about 4 hours to perform condensation reaction.

The distilling tube was exchanged with a T-shaped tube and decompression was started. Full vacuum (5 Pa) was achieved over about 1 hour and then the reaction was continued at 180° C. under reduced pressure (5 Pa) for about 390 minutes. The four-necked flask was broken to take out the obtained product. Solid phase polymerization was performed at a reaction temperature of 150° C. to increase the molecular weight of the obtained product. The number average molecular weight of the thus obtained polymer was Mn=6.0×10⁴.

The obtained resin composition was melt-kneaded with a single screw extruder (brand name: Laboplastomill produced by Toyo Seiki Seisaku-sho, Ltd., screw diameter: φ20, L/D=25) at a cylinder temperature of 190° C. to extrude in the shape of a strand. The obtained strand was palletized with a pelletizer after cooling to obtain resin composition pellets.

### Example 2

A resin composition was prepared in the same way as in Example 1 except for the following changes to obtain resin composition pellets.

(a) Diol was changed to distilled ethylene glycol (186.2 g; molar ratio=1:3).

(b) The charge weight of the layer silicate composition was changed from 11.05 g to 9.58 g.

(c) The temperature to elevate over about 4 hours after the inner temperature reached 150° C. and the by-product water generated by the condensation reaction began to flow out was changed from 170° C. to 280° C.

(d) The temperature at which the reaction was continued under reduced pressure (5 Pa) was changed from 180° C. to 280° C.

Solid phase polymerization was performed at a reaction temperature of 180° C. to increase the molecular weight of the obtained product. The number average molecular weight of the thus obtained polymer was Mn=6.3×10⁴.

### Example 3

A resin composition was prepared in the same way as in Example 1 except for the following changes to obtain resin composition pellets.

(a) Diol was changed to distilled 1,3-propanediol (228.3 g; molar ratio=1:3).

(b) The charge weight of the layer silicate composition was changed from 11.05 g to 10.32 g.

(c) The temperature to elevate over about 4 hours after the inner temperature reached 150° C. and the by-product water generated by the condensation reaction began to flow out was changed from 180° C. to 230° C.

(d) The temperature at which the reaction was continued under reduced pressure (5 Pa) was changed from 180° C. to 230° C.

Solid phase polymerization was performed at a reaction temperature of 140° C. to increase the molecular weight of the obtained product. The number average molecular weight of the thus obtained polymer was Mn=4.9×10⁴.

### Example 4

A resin composition was prepared in the same way as in Example 1 except for the following changes to obtain resin composition pellets. The number average molecular weight of the obtained polymer was Mn=6.0×10⁴.

(a) Montmorillonite was replaced with an expandable mica (cation exchange capacity 120 milliequivalent/100 g, Somasif ME-100 (brand name) produced by Co-op Chemical Co., Ltd.).

### Example 5

A layer silicate composition was prepared in the same way as in Example 1 except for the following changes.

(a) 10 mass % aqueous solution of choline chloride was replaced with 10 mass % aqueous solution of oleyldipolyoxyethylenemethylammonium chloride (polymerization degree of ethylene oxide x+y=2).

In addition, resin pellets were obtained by preparing a resin in the same way as in Example 1 except for charging no layer silicate composition into the four-necked flask. The number average molecular weight of the polymer obtained at this time was Mn=6.0×10⁴.

5 parts by mass of the obtained layer silicate composition and 95 parts by mass of the resin pellet were cast in a twin screw extruder (Laboplastomill (brand name): produced by Toyo Seiki Seisaku-sho, Ltd., screw diameter: +26, L/D=25). The mixture was melt-kneaded at a cylinder temperature of 180° C., screw rotation number of 150 rpm and discharge rate of 2 kg/h, extruded in the shape of a strand and pelletized with a pelletizer after cooling to obtain resin composition pellets.

### Example 6

A layer silicate composition was prepared in the same way as in Example 1 except for the following changes.

(a) 10 mass % aqueous solution of choline chloride was replaced with 10 mass % aqueous solution of oleyldipolyoxyethylenemethylammonium chloride (polymerization degree of ethylene oxide x+y=5).

In addition, resin pellets were obtained by preparing a resin in the same way as in Example 1 except for charging no layer silicate composition into the four-necked flask. The number average molecular weight of the polymer obtained at this time was Mn=6.0×10⁴.

5 parts by mass of the obtained layer silicate composition and 95 parts by mass of the resin pellets were processed as in Example 5 to obtain resin composition pellets.

### Example 7

A layer silicate composition was prepared in the same way as in Example 1 except for the following changes.

(a) 10 mass % aqueous solution of choline chloride was replaced with 10 mass % aqueous solution of oleyldipolyoxyethylenemethylammonium chloride (polymerization degree of ethylene oxide x+y=10).

In addition, resin pellets were obtained by preparing a resin in the same way as in Example 1 except for charging no layer silicate composition into the four-necked flask. The number average molecular weight of the polymer obtained at this time was Mn=6.0×10⁴.

5 parts by mass of the obtained layer silicate composition and 95 parts by mass of the resin pellets were processed as in Example 5 to obtain resin composition pellets.

### Example 8

A layer silicate composition was prepared in the same way as in Example 1 except for the following changes.

(a) 10 mass % aqueous solution of choline chloride was replaced with 10 mass % aqueous solution of oleyldipolyoxyethylenemethylammonium chloride (polymerization degree of ethylene oxide x+y 2).

(b) Montmorillonite was replaced with an expandable mica (cation exchange capacity 120 milliequivalent/100 g, Somasif ME-100 (brand name) produced by Co-op Chemical Co., Ltd.).

In addition, resin pellets were obtained by preparing a resin in the same way as in Example 1 except for charging no layer silicate composition into the four-necked flask. The number average molecular weight of the polymer obtained then was Mn=6.0×10⁴. 5 parts by mass of the obtained layer silicate composition and 95 parts by mass of the resin pellets were processed as in Example 5 to obtain resin composition pellets.

### Example 9

A layer silicate composition was prepared in the same way as in Example 1 except for the following changes.

(a) 10 mass % aqueous solution of choline chloride was replaced with 10 mass % aqueous solution of oleyldipolyoxyethylenemethylammonium chloride (polymerization degree of ethylene oxide x+y=5).

(b) Montmorillonite was replaced with an expandable mica (cation exchange capacity 120 milliequivalent/100 g, Somasif ME-100 (brand name) produced by Co-op Chemical Co., Ltd.).

In addition, resin pellets were obtained by preparing a resin in the same way as in Example 1 except for charging no layer silicate composition into the four-necked flask. The number average molecular weight of the polymer obtained at this time was Mn=6.0×10⁴. 5 parts by mass of the obtained layer silicate composition and 95 parts by mass of the resin pellets were processed as in Example 5 to obtain resin composition pellets.

### Example 10

Resin composition pellets were prepared in the same way as in Example 9 except for the following changes.

(a) The amount of the layer silicate composition was changed from 5 parts by mass to 10 parts by mass.

(b) The amount of the resin composition pellets was changed from 95 parts by mass to 90 parts by mass.

### Comparative Example 1

Resin composition pellets were prepared in the same way as in Example 1 except that no layer silicate composition was prepared and that no layer silicate composition was charged into the four-necked flask. The number average molecular weight of the polymer obtained at this time was Mn=6.0×10⁴.

(Evaluation of Resin Compositions and Resins)

Pellets obtained in Examples 1 to 10 and Comparative Example 1 were dried at 80° C. for four hours or more. The dried pellets were injection molded with an injection molding machine (SG50)(brand name): produced by Sumitomo Heavy Industries, Ltd., screw diameter φ22) at a cylinder temperature of 190° C. and a die temperature of 110° C. to produce molded articles (10×80×4.0 mm). Tests were performed following according to the ISO standards (IS0178, IS0179, IS075) on the produced molded articles to evaluate the properties thereof. All the obtained results are shown in Tables 1 and 2.

It has become clear from the results shown in Tables 1 and 2 that heat resistance and mechanical strength have been improved by introducing a layer silicate composition into a polymer having a furan ring skeleton. In addition, it has become clear from Table 2 that there was a difference in the heat resistance of the resin composition depending on the degree of polymerization of ethylene oxide in a hydroxyammonium compound and heat resistance was excellent at a particular degree of polymerization.

TABLE 1

| | | | | | Comparative |
|---|---|---|---|---|---|
| | Example | | | | Example |
| No. | 1 | 2 | 3 | 4 | 1 |
| Kind of layer | Mont- | mont- | mont- | expandable | — |
| silicate | morillonite | morillonite | morillonite | mica | |
| Polyhydric | 1,4- | ethylene- | 1,3- | 1,4- | 1,4- |
| alcohol | butanediol | glycol | propanediol | butanediol | butanediol |
| Amount of | 5 | 5 | 5 | 5 | — |
| layer | | | | | |
| silicate | | | | | |
| composition | | | | | |
| (part by mass) | | | | | |
| Amount of | 95 | 95 | 95 | 95 | 100 |
| polymer (part | | | | | |
| by mass) | | | | | |
| Bending | 63 | 55 | 56 | 68 | 83 |
| strength (Mpa) | | | | | |
| ISO178 | | | | | |
| Flexural | 4030 | 3650 | 3550 | 4160 | 3200 |
| modulus (Mpa) | | | | | |
| ISO178 | | | | | |
| Charpy impact | 2 | 1.2 | 0.6 | 2 | 0.8 |
| value (kJ/m²) | | | | | |
| ISO179 | | | | | |
| Deflection | 118 | 113 | 115 | 123 | 93 |
| temperature | | | | | |
| under load | | | | | |
| 0.45 MPa (° C.) | | | | | |
| ISO75 | | | | | |

TABLE 2

| | | | | | | | Comparative |
|---|---|---|---|---|---|---|---|
| | Example | | | | | | Example |
| No. | 5 | 6 | 7 | 8 | 9 | 10 | 1 |
| Kind of | mont- | mont- | mont- | expandable | Expandable | expandable | |
| layered | morillonite | morillonite | morillonite | mica | mica | mica | |
| siilcate | | | | | | | |
| Polymerization | 2 | 5 | 10 | 2 | 5 | 5 | |
| degree of | | | | | | | |
| ethylene | | | | | | | |
| oxide in | | | | | | | |
| hydroxyammonium | | | | | | | |
| compound | | | | | | | |
| (x + y) | | | | | | | |
| Amount of | 5 | 5 | 5 | 5 | 5 | 10 | |
| layer | | | | | | | |
| silicate | | | | | | | |
| composition | | | | | | | |
| (part by mass) | | | | | | | |
| Amount of | 95 | 95 | 95 | 95 | 95 | 90 | 100 |
| polymer | | | | | | | |
| (part by mass) | | | | | | | |
| Deflection | 103 | 106 | 98 | 108 | 111 | 122 | 93 |
| temperature | | | | | | | |
| under load | | | | | | | |
| 0.45 MPa (° C.) | | | | | | | |
| ISO75 | | | | | | | |
| Deflection | 81 | 90 | 77 | 94 | 101 | 108 | 75 |
| temperature | | | | | | | |
| under load | | | | | | | |
| 0.7 MPa (° C.) | | | | | | | |
| ISO75 | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-183201, filed Jul. 12, 2007, which is hereby incorporated by reference herein in its entirety.

What is claimed is:

1. A resin composition comprising a layer silicate composition and a polymer having a repeating unit represented by the following formula (1): 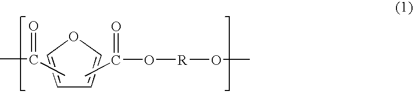
wherein R represents a group having a valence of 2 or more and selected from the group consisting of an aromatic group, an aliphatic hydrocarbon group and an alicyclic hydrocarbon group.

2. The resin composition according to claim 1 obtained by conducting a reaction of a mixture including a compound represented by the following formula (2) or a furandicarboxylic acid anhydride, a polyhydric alcohol represented by the following formula (3) and the layer silicate composition: 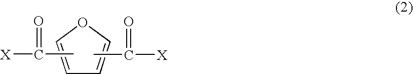
wherein X represents a hydroxy group, an alkoxy group or a halogen atom;
R(OH)ₘ (3)
wherein R¹ represents a group having a valence of m and selected from the group consisting of an aromatic group, an aliphatic hydrocarbon group and an alicyclic hydrocarbon group, and m represents an integer of 2 or more.

3. The resin composition according to claim 2, wherein the compound represented by the formula (2) is at least one compound selected from the group consisting of 2,5-furandicarboxylic acid, dimethyl 2,5-furandicarboxylate, diethyl 2,5-furandicarboxylate and 2,5-furandicarboxylic acid dichloride.

4. The resin composition according to claim 2, wherein the polyhydric alcohol represented by the formula (3) is ethylene glycol, 1,3-propanediol or 1,4-butanediol.

5. The resin composition according to claim 1, wherein the layer silicate composition is obtained by organizing a layer silicate with a hydroxyammonium compound.

6. The resin composition according to claim 5, wherein the hydroxyammonium compound is at least one compound selected from the group consisting of trimethyl(2-hydroxyethyl)ammonium chloride, oleylbis(2-hydroxyethyl)methylammonium chloride, methyl/tallowbis(2-hydroxyethyl)methylammonium chloride and alkylbis(2-hydroxyethyl)methylammonium chloride.

7. The resin composition according to claim 1 obtained by melt-kneading a polymer having a repeating unit represented by the formula (1) and a layer silicate composition.

8. The resin composition according to claim 7, wherein the polymer having a repeating unit represented by the formula (1) is obtained by reacting a compound represented by the following formula (2) or a furandicarboxylic acid anhydride and a polyhydric alcohol represented by the following formula (3): 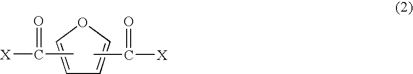
wherein X represents a hydroxy group, an alkoxy group or a halogen atom;
R¹(OH)ₘ (3)
wherein R¹ represents a group having a valence of m and selected from the group consisting of an aromatic group, an aliphatic hydrocarbon group and an alicyclic hydrocarbon group, and m represents an integer of 2 or more.

9. The resin composition according to claim 8, wherein the compound represented by the formula (2) is at least one compound selected from the group consisting of 2,5-furandicarboxylic acid, dimethyl 2,5-furandicarboxylate, diethyl 2,5-furandicarboxylate and 2,5-furandicarboxylic acid dichloride.

10. The resin composition according to claim 8, wherein the polyhydric alcohol represented by the formula (3) is ethylene glycol, 1,3-propanediol or 1,4-butanediol.

11. The resin composition according to claim 7, wherein the layer silicate composition is obtained by organizing a layer silicate with a hydroxyammonium compound.

12. The resin composition according to claim 11, wherein the hydroxyammonium compound is a compound represented by the following formula (4): 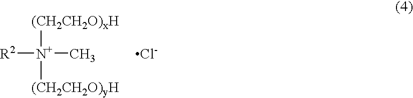
wherein R² represents a hydrogen atom or a saturated or unsaturated hydrocarbon group having 1 or more and 25 or less carbon atoms, x and y may be the same or different, and the total of x and y represents an integer of 2 or more and 10 or less.

13. The resin composition according to claim 5, wherein the layer silicate is a smectite clay mineral or an expandable mica.

14. The resin composition according to claim 1, wherein the content of the layer silicate composition is 1 part by mass or more and 20 parts by mass or less for 100 parts by mass of the polymer having a repeating unit represented by the formula (1).
